(19) United States
(12) Patent Application Publication
(10) Pub. No.: US 2013/0234912 A1
(43) Pub. Date: Sep. 12, 2013

(54) ANTENNA APPARATUS

(71) Applicants: SUMITOMO ELECTRIC PRINTED CIRCUITS, INC., Koka-shi (JP); SUMITOMO ELECTRIC INDUSTRIES, LTD., Osaka (JP)

(72) Inventors: Masahiko KOUCHI, Koka-shi (JP); Katsuyuki IMAI, Osaka (JP); Masatoshi KURODA, Osaka (JP); Rikio TANAKA, Osaka (JP)

(73) Assignees: SUMITOMO ELECTRIC INDUSTRIES, LTD., Osaka (JP); SUMITOMO ELECTRIC PRINTED CIRCUITS, INC., Koka-shi (JP)

(21) Appl. No.: 13/785,593

(22) Filed: Mar. 5, 2013

Related U.S. Application Data
(60) Provisional application No. 61/703,385, filed on Sep. 20, 2012.

(30) Foreign Application Priority Data
Mar. 7, 2012 (JP) 2012-050493

(51) Int. Cl. H01Q 1/38

(52) U.S. Cl. CPC H01Q 1/38
USPC 343/906

(57) ABSTRACT

An antenna apparatus capable of improving antenna characteristics as well as miniaturizing a size is provided. An antenna apparatus includes a base, an antenna conductor, and a terminal as an external connection terminal. The base is made of a dielectric composite material containing resin and ceramic powder. The antenna conductor is arranged on a surface of the base. The terminal is electrically connected to the antenna conductor. A relative permittivity (∈ᵣ) and a dielectric tangent (tan δ) of the dielectric composite material satisfy a relation of: tan δ≦0.0024×e^{(0.0341×∈r)}.

### BACKGROUND OF THE INVENTION

1. Field of the Invention

The present invention relates to an antenna apparatus, and more particularly to an antenna apparatus employing a dielectric.

2. Description of the Background Art

Conventionally, there has been known a dielectric antenna including an antenna conductor provided on a surface of a dielectric (for example, refer to Japanese Patent Laying-Open No. 2011-160368). Japanese Patent Laying-Open No. 2011-160368 discloses a dielectric antenna including a flexible substrate fixed to a surface of a molded body by an adhesive or the like. The flexible substrate has an emission electrode formed thereon, and the molded body is made of a composite material including dielectric ceramics and resin. According to the disclosure of Japanese Patent Laying-Open No. 2011-160368, a characteristic value (Q factor) of the composite material constituting the molded body is set to be within a predetermined range in a predetermined frequency band area to improve efficiency and an attenuated reflection property of the antenna.

However, Japanese Patent Laying-Open No. 2011-160368 does not disclose adjustment for physical properties of the molded body in light of miniaturization of the antenna. Such dielectric antenna described above is often employed in relatively small electronic equipment, as exemplified by mobile equipment such a mobile phone, a lap-top personal computer, and the like. Therefore, improvement in antenna characteristics as well as miniaturization of the size have been desired strongly. Further, the antenna characteristics may be changed sometimes when a user holds mobile equipment or the like in hand. Suppression of such a change in the antenna characteristics has also been desired.

### SUMMARY OF THE INVENTION

The present invention was achieved to solve such problems described above, and its object is to provide an antenna apparatus capable of improving antenna characteristics as well as miniaturizing the size.

Another object of the present invention is to provide an antenna apparatus capable of suppressing a change in characteristics further as compared to the conventional manner in the state where a human body is located in proximity.

An antenna apparatus according to the present invention includes a base, an antenna conductor, and an external connection terminal. The base is made of a dielectric composite material containing resin and ceramic powder. The antenna conductor is connected to the base. The external connection terminal is electrically connected to the antenna conductor. A relative permittivity (∈ᵣ) and a dielectric tangent (tan δ) of the dielectric composite material satisfy the relation of: tan δ≦0.0024×e^{(0.0341×∈r)}.

According to the manner described above, setting the relative permittivity to be greater than that of the base employed in the conventional antenna apparatus can shorten the wavelength of a signal propagated to the antenna apparatus. Therefore, the antenna apparatus can be miniaturized. Further, employing the dielectric composite material containing resin and ceramic powder can reduce the dielectric tangent of the antenna apparatus sufficiently. Therefore, the energy loss can be reduced in the antenna apparatus. Consequently, an antenna apparatus having superior characteristics can be achieved.

Further, the antenna apparatus according to the present invention includes a base, an antenna conductor, and an external connection terminal. The base is made of a dielectric composite material containing resin and ceramic powder. The antenna conductor is arranged on a surface of the base. The external connection terminal is electrically connected to the antenna conductor. A relative permittivity of the dielectric composite material is greater than or equal to 4 and less than or equal to 50.

According to the manner described above, setting the relative permittivity to be greater than that of the base employed in the conventional antenna apparatus can shorten the wavelength of a signal propagated to the antenna apparatus. Therefore, the antenna apparatus can be miniaturized. Further, even in the state where a human body is located in proximity to mobile equipment adopting the antenna apparatus (for example, in the state where a user holds the mobile equipment in hand), a change in the characteristics can be suppressed further as compared to the state where the human body is not located in proximity to the mobile equipment.

According to the present invention, an antenna apparatus having a miniaturized size and exhibiting improved performance can be achieved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic perspective view representing a first embodiment of an antenna apparatus according to the present invention.

FIG. 2 is a schematic cross-sectional view taken along the line segment II-II of FIG. 1.

FIG. 3 is a schematic cross-sectional view representing a modified example of the antenna apparatus shown in FIGS. 1 and 2.

FIG. 4 is a flowchart for describing a method for manufacturing the antenna apparatuses shown in FIGS. 1-3.

FIG. 5 is a schematic cross-sectional view representing a second embodiment of the antenna apparatus according to the present invention.

FIG. 6 is a schematic view representing a third embodiment of the antenna apparatus according to the present invention.

FIG. 7 is a schematic cross-sectional view taken along the line segment VII-VII of FIG. 6.

FIG. 8 is a schematic view representing a fourth embodiment of the antenna apparatus according to the present invention.

FIG. 9 is a flowchart for describing a method for manufacturing the antenna apparatus shown in FIG. 8.

FIG. 10 is a schematic view for describing a method for manufacturing the antenna apparatus shown in FIG. 8.

FIG. 11 is a schematic view for describing a method for manufacturing the antenna apparatus shown in FIG. 8.

FIG. 12 is a schematic cross-sectional view representing a first modified example of the fourth embodiment of the antenna apparatus according to the present invention.

FIG. 13 is a schematic view for describing a method for manufacturing the antenna apparatus shown in FIG. 12.

FIG. 14 is a schematic view showing a second modified example of the fourth embodiment of the antenna apparatus according to the present invention.

FIG. 15 is a schematic view showing a third modified example of the fourth embodiment of the antenna apparatus according to the present invention.

FIG. 16 is a schematic view showing a fourth modified example of the fourth embodiment of the antenna apparatus according to the present invention.

FIG. 17 is a schematic view showing a fifth modified example of the fourth embodiment of the antenna apparatus according to the present invention.

FIG. 18 is a schematic view for describing mobile equipment employing the antenna apparatus shown in FIG. 8,

FIG. 19 is a schematic view for describing a modified example of mobile equipment employing the antenna apparatus shown in FIG. 8.

FIG. 20 is a schematic view representing mobile equipment including the antenna apparatus shown in FIG. 6.

FIG. 21 represents a photograph showing an antenna apparatus according to an example of the present invention.

FIG. 22 represents graphs showing measurement results for a comparative example and an example of the present invention.

FIG. 23 represents graphs showing measurement results for the comparative example and the example of the present invention.

FIG. 24 represents graphs showing measurement results for the comparative example and the example of the present invention.

FIG. 25 represents graphs showing measurement results for the comparative example and the example of the present invention.

FIG. 26 represents graphs showing measurement results for the comparative example and the example of the present invention.

FIG. 27 represents graphs showing measurement results for the comparative example and the example of the present invention.

FIG. 28 represents graphs showing measurement results for the comparative example and the example of the present invention.

FIG. 29 represents graphs showing measurement results for the comparative example and the example of the present invention.

FIG. 30 represents an equivalent circuit of the antenna apparatus.

FIG. 31 represents graphs showing calculation results for the comparative example and the example of the present invention.

FIG. 32 represents graphs showing calculation results for the example of the present invention.

FIG. 33 represents graphs showing calculation results for the comparative example.

FIG. 34 is a schematic view representing a modified example of the antenna apparatus shown in FIG. 15.

FIG. 35 is a schematic view representing a modified example of the antenna apparatus shown in FIG. 15.

FIG. 36 is a schematic view representing a modified example of the antenna apparatus shown in FIG. 15.

### DESCRIPTION OF THE PREFERRED EMBODIMENTS

In the following, embodiments of the present invention will be described with reference to the drawings. In the drawings, the same or corresponding parts have the same reference numerals allotted, and description thereof will not be repeated.

### First Embodiment

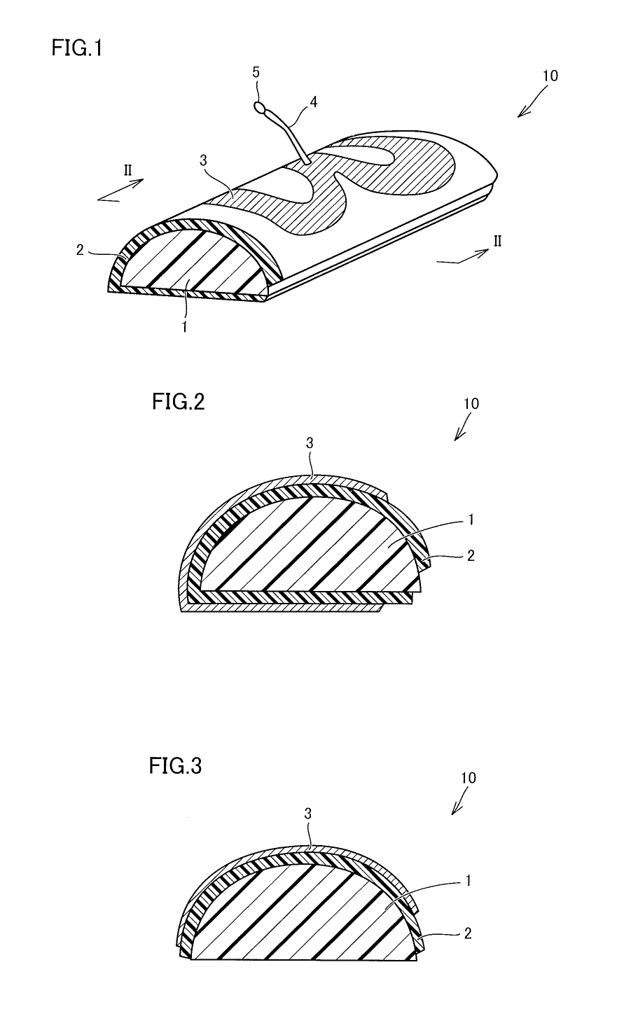

A first embodiment of an antenna apparatus according to the present invention will be described with reference to FIGS. 1 and 2. As shown in FIGS. 1 and 2, an antenna apparatus 10 according to the present invention includes a base 1 made of a dielectric, and a flexible substrate 2 fixed on a surface of base 1. On the surface of flexible substrate 2, an antenna conductor 3 is formed to have a predetermined planar shape. A leading wire 4 is connected to antenna conductor 3. Leading wire 4 has the one end connected to antenna conductor 3 and the other opposite end connected to a terminal 5.

A cross-sectional shape of base 1 is semicircular as shown in FIG. 2. In other words, while a bottom face of base 1 is substantially planar, and an upper face of base 1 is curved. Flexible substrate 2 is fixed to base 1 so as to extend from the curved face (the curved face bulging outward) to the back face of base 1.

Flexible substrate 2 can be fixed to base 1 by any given method. For example, an adhesive, an adhesive tape member, or the like may be used to fix flexible substrate 2 to base 1. The entire face (back face) of flexible substrate 2 opposing base 1 may be fixed to base 1. The back face of flexible substrate 2 may be fixed partially (for example, at some parts) to base 1.

Antenna conductor 3 is formed on the surface of flexible substrate 2 to have a predetermined planar shape. Antenna conductor 3 may be formed at any given position on the surface of flexible substrate 2 (in other words, at any given position on the surface of base 1), and may be formed so as to extend from the curved surface to the flat back face of base 1, as shown in FIG. 2.

As to antenna apparatus 10 according to the present invention, base 1 is constituted by a dielectric composite material containing resin and ceramic powder. Further, the composition of the dielectric composite material constituting base 1 is adjusted such that a relative permittivity (∈ᵣ) and a dielectric tangent (tan δ) of the dielectric composite material constituting base 1 satisfy the following relation of: tan δ≦0.0024×e^{(0.0341×∈r)}. According to the manner described above, as to base 1 constituting the antenna apparatus, the relative permittivity is set to be relatively greater, and the value of the dielectric tangent is set to be relatively lower, as compared to the dielectrics of conventional antenna apparatuses. Such antenna apparatus 10 can be miniaturized by setting the relative permittivity to be greater and can be improved in the antenna characteristics by setting the value of dielectric tangent to be lower. Further, when antenna apparatus 10 is adopted in mobile equipment such as a mobile phone, reduction in the gain of the antenna apparatus can be suppressed, and the electrostatic capacity (C), assuming antenna apparatus 10 as an LC resonance circuit, can be set greater, as compared to the conventional manner. Therefore, the effect of suppressing the influence exerted in the case where the mobile electric equipment is held in human hand (a change in the frequency characteristics of antenna apparatus 10 due to a change in the electrostatic capacity of the antenna apparatus in the case where mobile equipment is held in human hand) can be achieved. Consequently, the stable antenna characteristics can be achieved regardless of the status of using mobile equipment.

As shown in FIG. 3, antenna conductor 3 may be formed only on the curved surface of base 1. In this case, antenna conductor 3 may be arranged on the curved surface of base 1 by the method of allowing flexible substrate 2 having antenna conductor 3 formed thereon to be adhered only on the curved upper surface of base 1, as shown in FIG. 3.

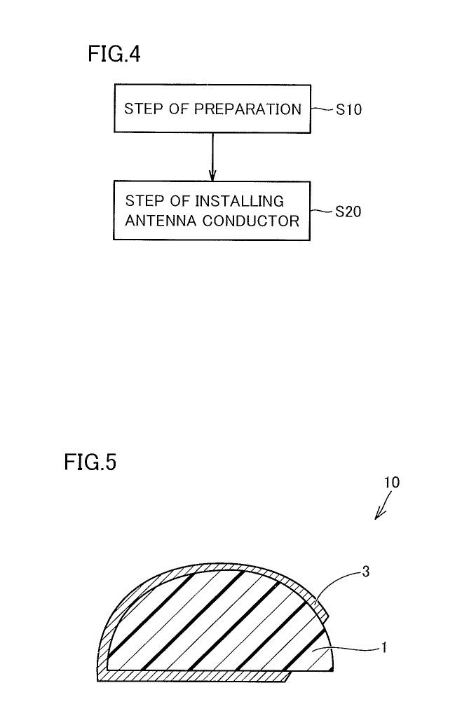

Next, a method for manufacturing the antenna apparatuses shown in FIGS. 1-3 will be described with reference to FIG. 4.

In the method for manufacturing the antenna apparatus of the first embodiment according to the present invention, the step of preparation (S10) is firstly conducted. Specifically, the constituting members such as base 1, flexible substrate 2 having antenna conductor 3 formed thereon, and the like constituting antenna apparatus 10 are prepared.

Next, the step of installing the antenna conductor (S20) shown in FIG. 4 is conducted. Specifically, flexible substrate 2 is connected and fixed to the surface of base 1. Any given method for fixing flexible substrate 2 to base 1 can be employed. For example, the method of using an adhesive, an adhesive tape, or the like, the method of connecting the flexible substrate to base 1 by using a fixing member (for example, a fixing pin, a screw, and the like), and the like can be employed. Leading wire 4 provided with terminal 5 may be connected to antenna conductor 3 formed on flexible substrate 2 before the step of installing the antenna conductor (S20). Alternatively, leading wire 4 may be connected after the step of installation (S20).

The antenna apparatuses shown in FIGS. 1-3 can be obtained by the manner described above.

### Second Embodiment

A second embodiment of the antenna apparatus according to the present invention will be described with reference to FIG. 5.

Antenna apparatus 10 shown in FIG. 5 basically has a structure similar to that of antenna apparatus 10 shown in FIGS. 1 and 2, but is different in that antenna conductor 3 is formed directly on the surface of base 1. In other words, antenna apparatus 10 shown in FIG. 5 has antenna conductor 3 formed directly on the surface of base 1 without employing flexible substrate 2 (refer to FIGS. 1 and 2). Leading wire 4 (refer to FIG. 1) is connected to antenna conductor 3 in a manner similarly employed in the antenna apparatus shown in FIG. 1, and terminal 5 (refer to FIG. 1) is provided on the other end of leading wire 4.

As a method for manufacturing antenna conductor 3, the method of applying a metal paste on the surface of base 1 so as to take the shape of antenna conductor 3 and applying a hardening treatment may be employed. Alternatively, any other given method may be employed to form antenna conductor 3. For example, a method employing plating may be employed, such as an additive process, vapor deposition, metal injection, laser direct structuring (LDS), and the like may be employed.

Antenna apparatus 10 having such a structure may also achieve the effect similar to that of the antenna apparatuses shown in FIGS. 1-3.

### Third Embodiment

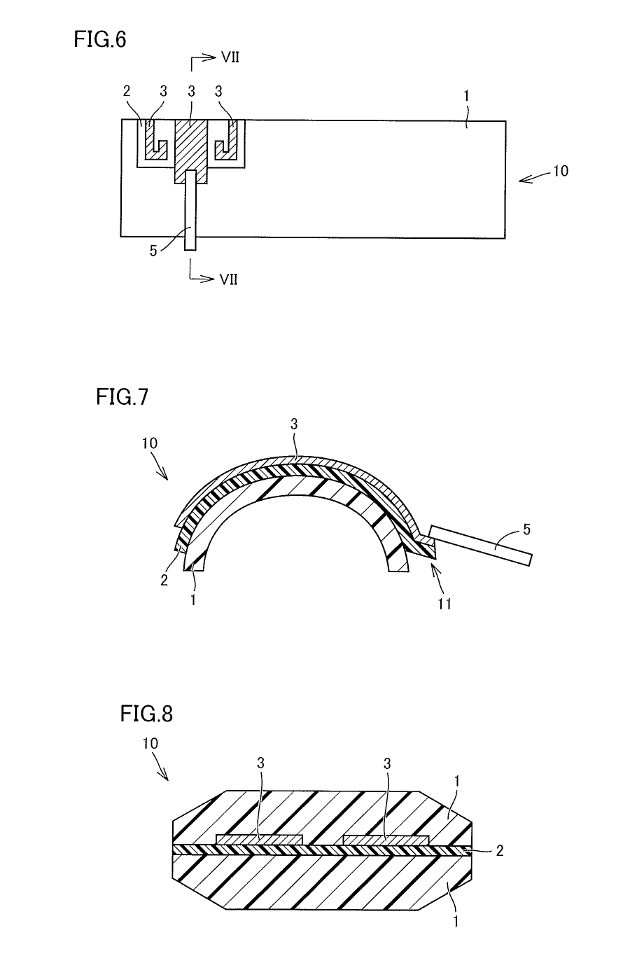

A third embodiment of the antenna apparatus according to the present invention will be described with reference to FIGS. 6 and 7.

Antenna apparatus 10 shown in FIGS. 6 and 7 basically has a structure similar to that of antenna apparatus 10 shown in FIGS. 1 and 2, but is different from antenna apparatus 10 shown in FIGS. 1 and 2 in the shapes of base 1 and flexible substrate 2. In other words, base 1 constituting antenna apparatus 10 shown in FIGS. 6 and 7 has a curved outer peripheral surface and is hollow inside. Describing in a different point of view, base 1 has a shape such that a plate body having a substantially constant thickness is bent. Further, flexible substrate 2 is arranged on a part of the surface of base 1. Antenna conductor 3 is arranged on the surface of flexible substrate 2. A part of the end of flexible substrate 2 is bent so as to extend away from the surface of base 1, as shown in FIG. 7. Terminal 5 is connected to antenna conductor 3 at the bent portion (terminal connection portion 11) of flexible substrate 2. The relative permittivity of the material constituting base 1 is greater than or equal to 4 and less than or equal to 50. As shown in FIG. 8, antenna apparatus 10 is arranged in mobile equipment 20.

According to this manner, similarly to antenna apparatus 10 shown in FIG. 1 and the like, antenna apparatus 10 can be miniaturized. Further, even in the state where a human body is located in proximity to mobile equipment 20 adopting antenna apparatus 10 (for example, in the state where a user holds mobile equipment 20 in hand), the change in characteristics of antenna apparatus 10 can be suppressed further as compared to the state where the human body is not located in proximity to mobile equipment 20.

### Fourth Embodiment

A fourth embodiment of the antenna apparatus according to the present invention will be described with reference to FIG. 8.

Antenna apparatus 10 shown in FIG. 8, basically similar to antenna apparatus 10 shown in FIGS. 1 and 2, includes flexible substrate 2 having antenna conductor 3 fixed on a surface thereof and base 1 made of a dielectric, but is different from antenna apparatus 10 shown in FIGS. 1 and 2 in a positional relationship between flexible substrate 2 and base 1. In other words, according to antenna apparatus 10 shown in FIG. 8, antenna conductors 3 and flexible substrate 2 are embedded in base 1. More particularly, flexible substrate 2 is arranged so as to extend across a substantially central portion in a thickness direction of base 1. Antenna conductor 3 embedded in base 1 is arranged on the surface of flexible substrate 2.

According to such configuration, an effect similar to that of antenna apparatus 10 shown in FIGS. 1 and 2 can be achieved. Further, since base 1 made of material exhibiting a high relative permittivity and a high dielectricity surrounds antenna conductors 3, the wavelength of a signal propagated to antenna conductors 3 can be shortened assuredly. Therefore, antenna apparatus 10 can be further miniaturized. Further, since antenna conductors 3 are covered with base 1, base 1 can be used as an insulating covering layer for antenna conductors 3. Therefore, an insulating layer which has been conventionally formed on a surface of antenna conductor 3 can be omitted or can be formed by a simplified manufacturing method.

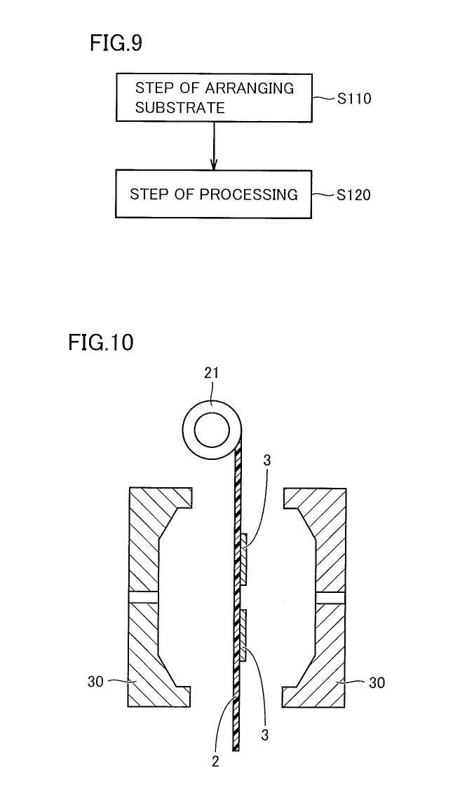

Next, a method for manufacturing antenna apparatus 10 shown in FIG. 8 will be described with reference to FIGS. 9-11. Antenna apparatus 10 shown in FIG. 8 can be manufactured by a so-called in-mold forming. Particularly, referring to FIG. 9, the step of arranging a substrate (S 110) is firstly conducted in the method for manufacturing antenna apparatus 10. In this step (S110), flexible substrate 2 is arranged between a pair of dies 30 opposing each other as shown in FIG. 10. Antenna conductors 3 are formed in advance on a surface of flexible substrate 2. Flexible substrate 2 may be processed to be individual flexible substrate 2 constituting single antenna apparatus 10 (for example, a cutting process is applied to form a predetermined contour). Alternatively, single belt-like flexible substrate 2 having a plurality of antenna conductors 3 arranged thereon as shown in FIG. 10 may be employed. For example, belt-like flexible substrate 2 may be in a form of a roll 21.

Next, as shown in FIG. 9, the step of processing (S 120) is conducted. Particularly, flexible substrate 2 is sandwiched between the pair of dies 30 as shown in FIG. 11, and then material for base 1 is poured into an inner portion of dies 30 having flexible substrate 2 arranged therebetween. Thereafter, the material is solidified to obtain base 1 having embedded therein flexible substrate 2 and antenna conductor 3. Further, after taking base 1 out of dies 30, flexible substrate 2 is cut along the contour of base 1. Accordingly, antenna apparatus 10 shown in FIG. 8 can be obtained.

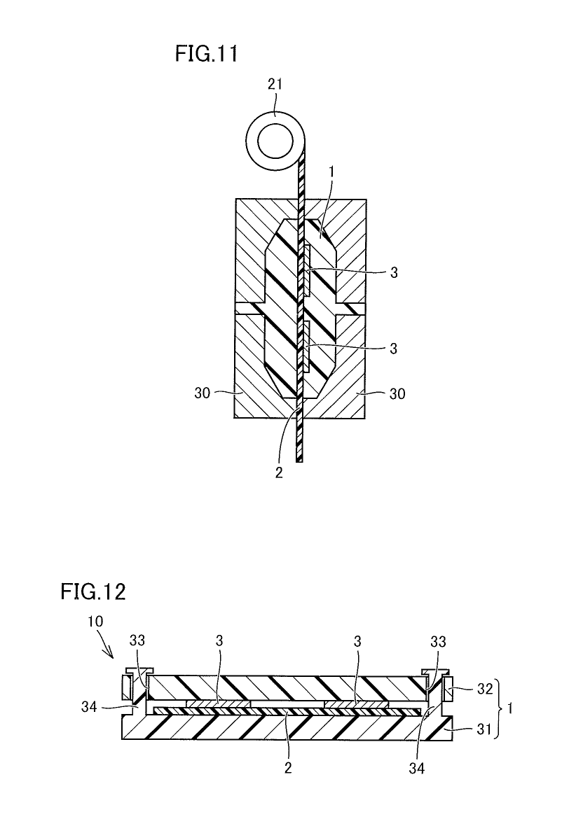

A first modified example of antenna apparatus 10 shown in FIG. 8 will be described with reference to FIG. 12. Antenna apparatus 10 shown in FIG. 12 basically has a structure similar to that of antenna apparatus 10 shown in FIG. 8, but is different from antenna apparatus 10 shown in FIG. 8 in a structure of base 1. In other words, base 1 of antenna apparatus 10 shown in FIG. 12 includes a plate-like first base 31 and a plate-like second base 32 arranged so as to sandwich flexible substrate 2 and antenna conductors 3.

First base 31 has protrusions 34 formed thereon. First base 31 has a plurality of protrusions 34 formed thereon. Further, protrusions 34 may be formed at any location on first base 31, but is preferably formed at an outer peripheral portion of first base 31 as shown in FIG. 12. Second base 32 has through holes 33 at positions opposite to protrusions 34. Protrusions 34 are inserted into and fixed at through holes 33. Any method can be employed as a method for fixing protrusions 34. For example, as shown in FIG. 12, protrusions 34 can be fixed at through holes 33 by elastically deforming leading end portions of protrusions 34 protruding from through holes 33 to allow a width of each leading end portion to be greater than a width of each through hole 33. With the configuration described above, an effect similar to that of antenna apparatus 10 shown in FIG. 8 can be achieved. Further, antenna apparatus 10 shown in FIG. 12 can be manufactured without employing dies 30 shown in FIG. 10. Therefore, manufacturing cost can be further reduced as compared to antenna apparatus 10 shown in FIG. 8.

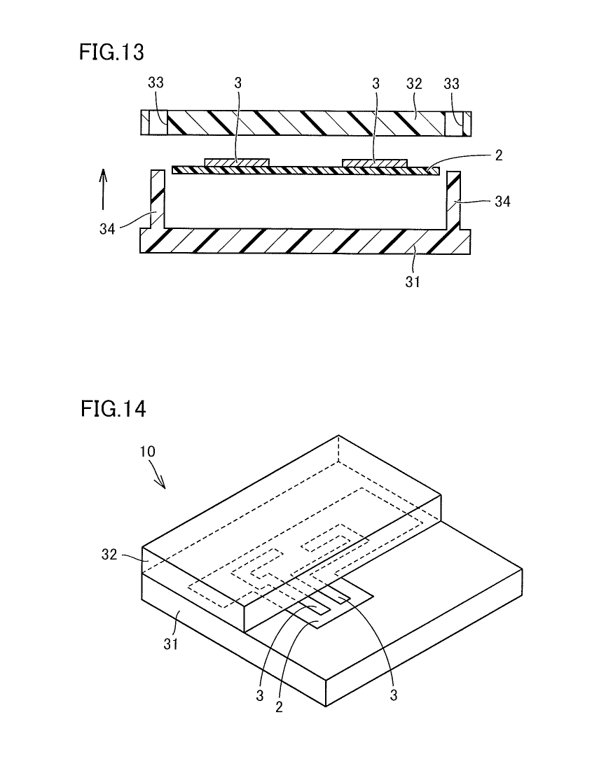

Next, a method for manufacturing antenna apparatus 10 shown in FIG. 12 will be described with reference to FIGS. 9, 12, and 13. Referring to FIG. 9, the step of arranging a substrate (S110) is firstly conducted in the method for manufacturing antenna apparatus 10. In this step (S110), flexible substrate 2 is arranged between first base 31 and second base 32 arranged opposite to each other as shown in FIG. 13. Antenna conductors 3 are formed in advance on a surface of flexible substrate 2. Flexible substrate 2 is processed in advance to be individual flexible substrate 2 constituting single antenna apparatus 10 (for example, a cutting process is applied to form a predetermined contour). Single belt-like flexible substrate 2 having a plurality of antenna conductors 3 arranged thereon as shown in FIG. 10 may be employed as flexible substrate 2.

Next, as shown in FIG. 9, the step of processing (S 120) is conducted. Particularly, first base 31 is pressed against second base 32 in the direction indicated by the arrow of FIG. 13. At this stage, protrusions 34 of first base 31 are inserted into through holes 33 of second base 32. Further, flexible substrate 2 is retained between first base 31 and second base 32 as shown in FIG. 12. Thereafter, a leading end portion of each protrusion 34 is processed to have a greater width. Consequently, first base 31 and second base 32 are connected and fixed. Consequently, base 1 retaining flexible substrate 2 and antenna conductor 3 inside is formed. Accordingly, antenna apparatus 10 shown in FIG. 8 can be obtained.

Protrusions 34 may be formed on an inner peripheral portion (for example, a central portion) of first base 31. In this case, holes may be formed in advance at positions opposite to protrusions 34 in flexible substrate 2. Accordingly, protrusions 34 are inserted into through holes 33 of second base 32 via the holes of flexible substrate 2. Accordingly, flexible substrate 2 can be fixed to base 1 more assuredly.

A second modified example of antenna apparatus 10 shown in FIG. 8 will be described with reference to FIG. 14. Antenna apparatus 10 shown in FIG. 14 basically has a structure similar to that of antenna apparatus 10 shown in FIG. 8, but is different from antenna apparatus 10 shown in FIG. 8 in a structure of base 1. In other words, base 1 of antenna apparatus 10 shown in FIG. 14 includes plate-like first base 31 and plate-like second base 32 arranged so as to sandwich flexible substrate 2 and antenna conductor 3. The size of first base 31 is greater than the size of second base 32. Therefore, on a surface (main surface) of first base 31 where second base 32 is connected, there is a region where a surface portion of first base 31 is exposed. On the exposed surface portion of first base 31, a part of flexible substrate 2 extends form a portion between first base 31 and second base 32. At the extending portion flexible substrate 2, portions of antenna conductors 3 are arranged so as to be exposed.

The planar shape of first base 31 and second base 32 may be a rectangular shape as shown in FIG. 14 or any other shape. Further, the method for connecting first base 31 and second base 32 may be the fixing method using protrusions and through holes similar to antenna apparatus 10 shown in FIG. 12, or may be the in-mold forming method as shown in FIGS. 9-11. Antenna apparatus 10 of such configuration may exhibit the effect similar to that of antenna apparatus 10 shown in FIG. 8.

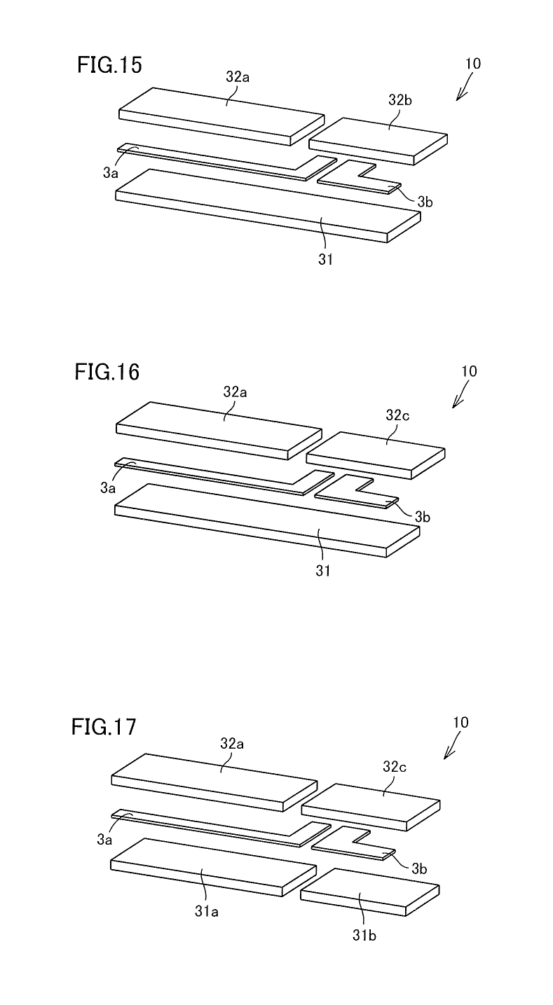

A third modified example of antenna apparatus 10 shown in FIG. 8 will be described with reference to FIG. 15. Antenna apparatus 10 shown in FIG. 15 basically has a structure similar to that of antenna apparatus 10 shown in FIG. 8, but is different from antenna apparatus 10 shown in FIG. 8 in a structure of base 1. In other words, base 1 of antenna apparatus 10 shown in FIG. 15 includes plate-like first base 31 and plate-like second bases 32a, 32b arranged in lamination so as to sandwich antenna conductors 3a, 3b. A planar shape of first base 31 has a rectangular plate-like shape. Further, each of second bases 32a, 32b has a size smaller than that of first base 31. First base 31 and second base 32 may be configured by a dielectric having characteristics different from that of second base 32a.

One antenna conductor 3a is arranged so as to be sandwiched between first base 31 and second base 32a. Further, the other antenna conductor 3b is arranged so as to be sandwiched between first base 32 and second base 32b. One antenna conductor 3a may constitute a low-band antenna circuit, and the other antenna conductor 3b may constitute a high-band antenna circuit. In a different point of view, a plurality of antenna conductors 3a, 3b are arranged so as to align on an upper surface of first base 31. Second bases 32a, 32b are arranged so as to cover a plurality of antenna conductors 3a, 3b. First base 31, antenna conductors 3a, 3b, and second bases 32a, 32b are laminated and fixed to each other. As a fixing method, any method may be employed such as a fixing method using an adhesive, thermal fusion bonding, or forming a mechanical fixing portion shown in FIG. 12. In this case, a relative permittivity of a dielectric constituting first base 31 and second base 32b may be greater than or equal to 1 and less than or equal to 20, and more preferably, greater than or equal to 1.7 and less than or equal to 13. Further, a relative permittivity of a dielectric constituting second base 32a may be greater than or equal to 2 and less than or equal to 50, and more preferably greater than or equal to 10 and less than or equal to 40.

As described above, the configuration of arranging a plurality of dielectrics in conformity with transmission bands of antenna conductors 3a, 3b may be employed. Accordingly, a dielectric of a type adapted to required performance of antenna conductors 3a, 3b may be employed for first base 31 and second bases 32a, 32b. Consequently, characteristic of the antenna apparatus can be improved further. Antenna conductors 3a, 3b may be arranged on the flexible substrate similarly to antenna apparatus 10 shown in FIG. 14.

A fourth modified example of antenna apparatus 10 shown in FIG. 8 will be described with reference to FIG. 16. Antenna apparatus 10 shown in FIG. 16 basically has a structure similar to that of antenna apparatus 10 shown in FIG. 15, but is different from antenna apparatus 10 shown in FIG. 15 in the configuration of first base 31 and second base 32c. In other words, second base 32c of antenna apparatus shown in FIG. 16 is made of a dielectric having characteristics different from that of first base 31. A relative permittivity of a dielectric constituting first base 31 may be greater than or equal to 1 and less than or equal to 30, and more preferably greater than or equal to 1.7 and less than or equal to 20. A relative permittivity of a dielectric constituting second base 32c may be greater than or equal to 1 and less than or equal to 20, and more preferably greater than or equal to 1.7 and less than or equal to 13. Antenna apparatus 10 having such configuration can achieve the effect similar to that of antenna apparatus 10 shown in FIG. 15, and a relative permittivity of a dielectric (first base 31 and second bases 32a, 32c) surrounding each of antenna conductors 3a, 3b can be adjusted individually.

A fifth modified example of antenna apparatus 10 shown in FIG. 8 will be described with reference to FIG. 17. Antenna apparatus 10 shown in FIG. 17 basically has a structure similar to that of antenna apparatus 10 shown in FIG. 16, but is different from antenna apparatus 10 shown in FIG. 16 in that two first bases 31a, 31b are provided. In other words, according to antenna apparatus 10 shown in FIG. 17, two first bases 31a, 31b are arranged so as to oppose second bases 32a, 32c. One first base 31a is made of a dielectric having the same characteristic (specifically, the same relative permittivity) as the dielectric constituting second base 32a. Further, the other first base 32b is made of a dielectric having the same characteristic as the dielectric constituting opposing second base 32c. Antenna apparatus 10 having such configuration can achieve the effect similar to that of antenna apparatus 10 shown in FIG. 15. First bases 31a, 31b and second bases 32a, 32c shown in FIG. 17 may be constituted by dielectrics having different characteristics (different relative permittivity). Further, antenna conductors 3a, 3b described above may employ any material and configuration as long as it is a dielectric. For example, a conductive plate such as a copper plate, or a conductive layer formed on a surface of first bases 31, 31a, 31b or on a surface of second bases 32a-32c by means of printing, plating, transfer, vapor deposition, or the like may be employed as antenna conductors 3a, 3b.

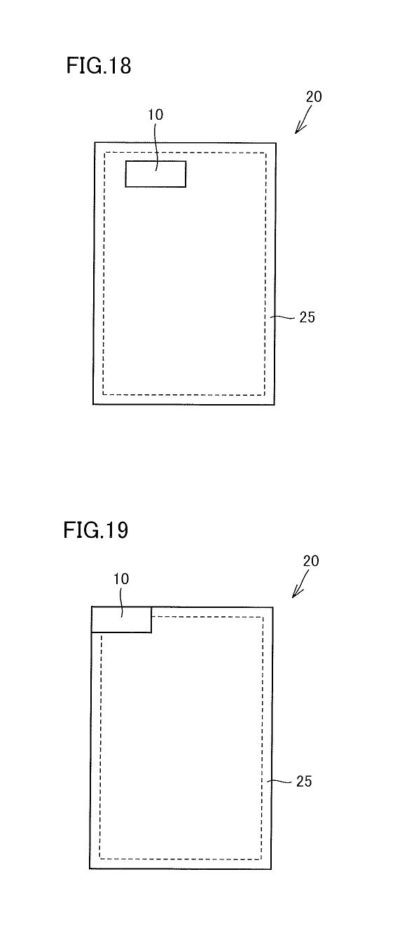

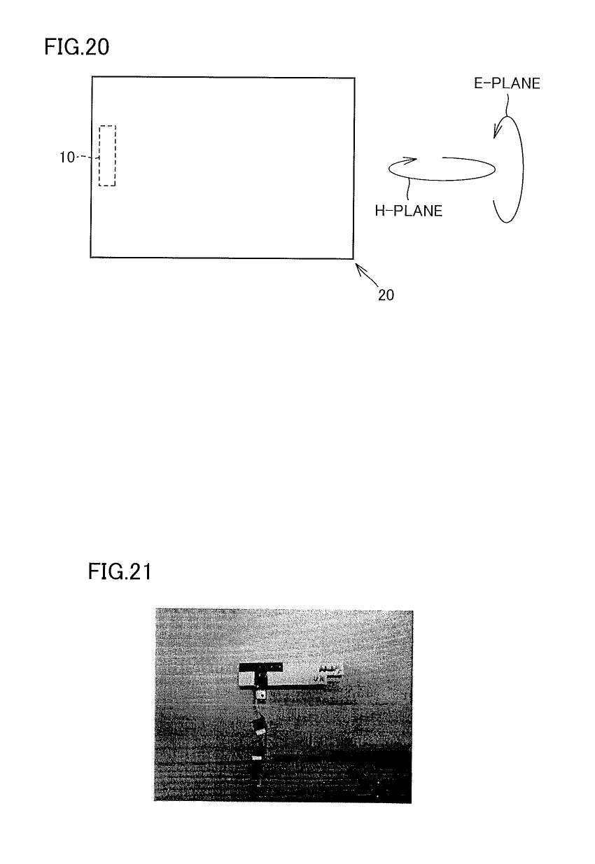

Mobile equipment employing the antenna apparatus shown in FIG. 8 will be described with reference to FIG. 18. As shown in FIG. 18, mobile equipment 20 is portable electronic equipment such as a mobile phone and a slate computer, and antenna apparatus 10 shown in FIG. 8 is arranged in a housing 25. Accordingly, antenna apparatus 10 according to the present invention can be miniaturized further than conventional antenna apparatuses. Therefore, miniaturization of mobile equipment 20 can be facilitated. Further, since antenna apparatus 10 employs material having a higher relative permittivity than conventional as base 1, deterioration of antenna characteristics (reduction of gain) can be suppressed in the case where mobile equipment 20 is held in hand by a person. As antenna apparatus 10 provided in mobile equipment 20 shown in FIG. 18, antenna apparatus 10 other than that shown in FIG. 8 can be employed. For example, antenna apparatuses 10 show in FIGS. 14-17 or antenna apparatus 10 of other embodiment can be employed.

Further, as shown in FIG. 19, antenna apparatus 10 shown in FIG. 8 may be employed as a part of housing 25 of mobile equipment 20. In this case, antenna apparatus 10 constitutes a part of housing 25 of mobile equipment 20, so that mobile equipment 20 can be miniaturized further than the case where antenna apparatus 10 is arranged in housing 25.

### Experimental Example 1

The following experiment was conducted to confirm the effect of the present invention.

<Sample>

An antenna apparatus according to an embodiment of the present invention as shown in FIG. 21 was prepared. The base employs a material having a relative permittivity of 16. Further, as a comparative example, a sample of the comparative example having a similar shape and including a base made of a material with a relative permittivity of 2.3 was prepared.

### EXPERIMENT

The antenna characteristics was measured in the states where: the antenna apparatus was provided alone (case 1); the antenna apparatus was arranged in a housing of slate electronic equipment (case 2); a phantom block representing a human body was arranged outside the portion of the electronic equipment where the antenna apparatus is arranged (case 3); and a person holding the electronic equipment in hand (case 4).

Further, as to case 2 and case 3, measurement for the antenna characteristics as to an H-plane and an E-plane shown in FIG. 8 was also conducted.

<Result>

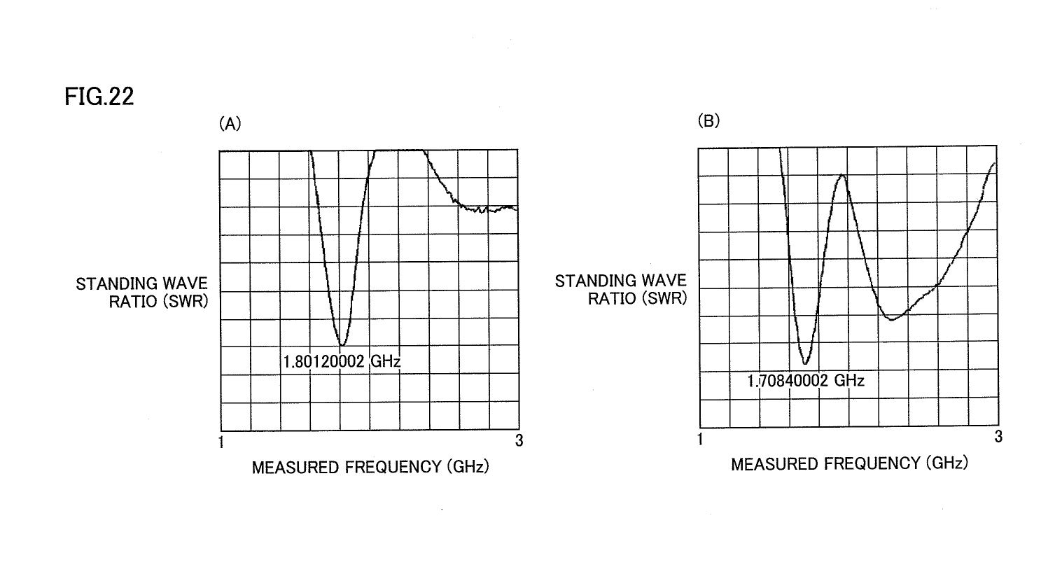

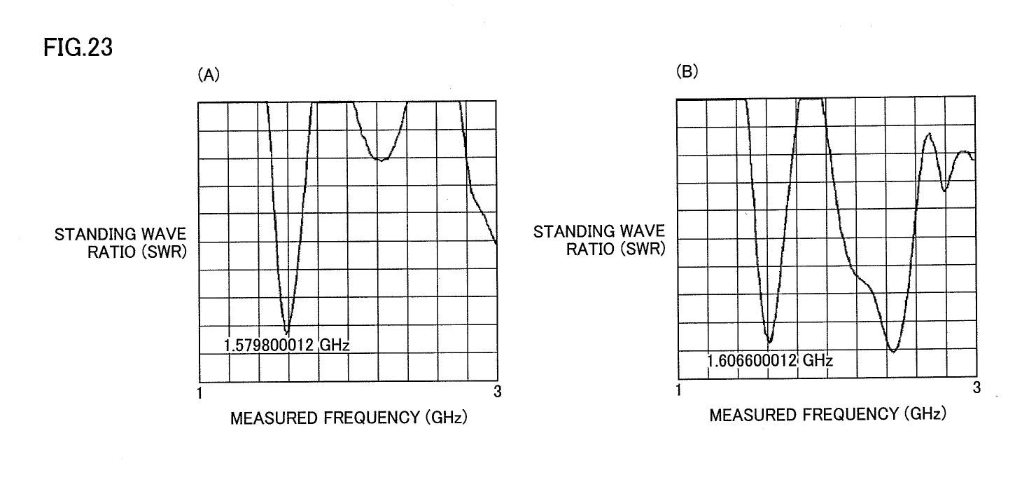

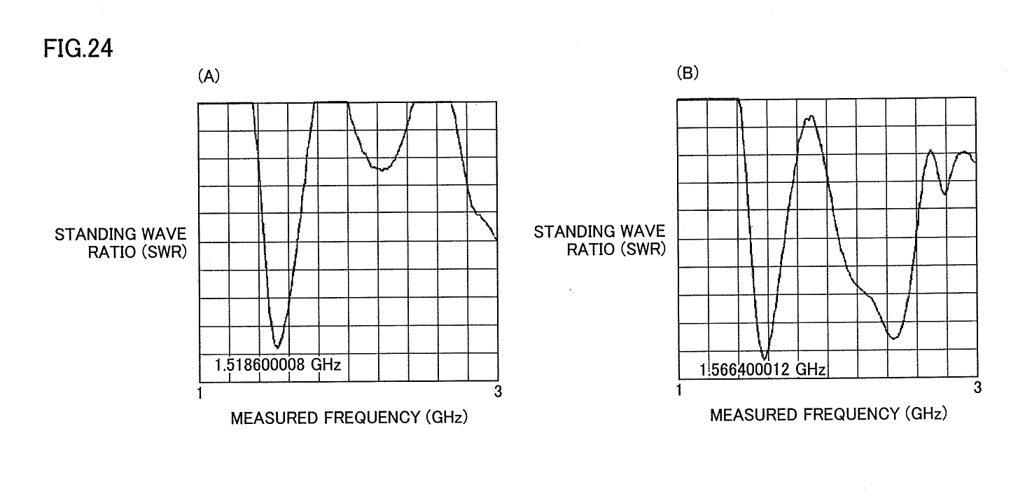

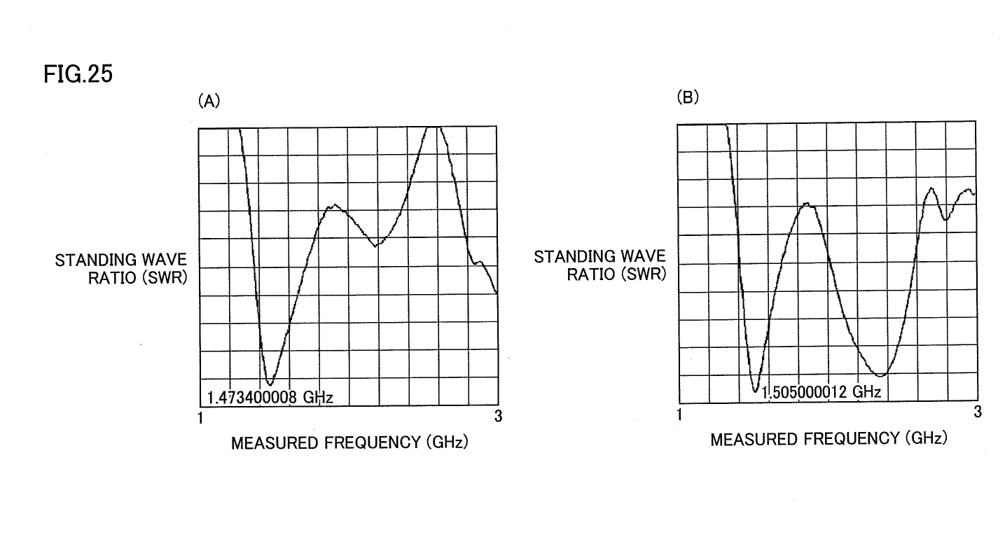

FIGS. 22-25 show the measurement results for the resonance frequencies in the cases 1 through 4, respectively. Item (A) of FIGS. 22-25 represent data related to the sample according to the comparative example, and item (B) of FIGS. 22-25 represent data related to the sample according to the example of the present invention. The vertical axis in each of FIGS. 22-25 represents a standing wave ratio (SWR) of a reflected wave (s11) at an input port, and the vertical axis represents a measured frequency. As can be seen, the sample of the present invention has less deviation in the resonance frequencies between case 2 and case 3 (or case 4) and is less likely to be affected by a human body than the sample of the comparative example.

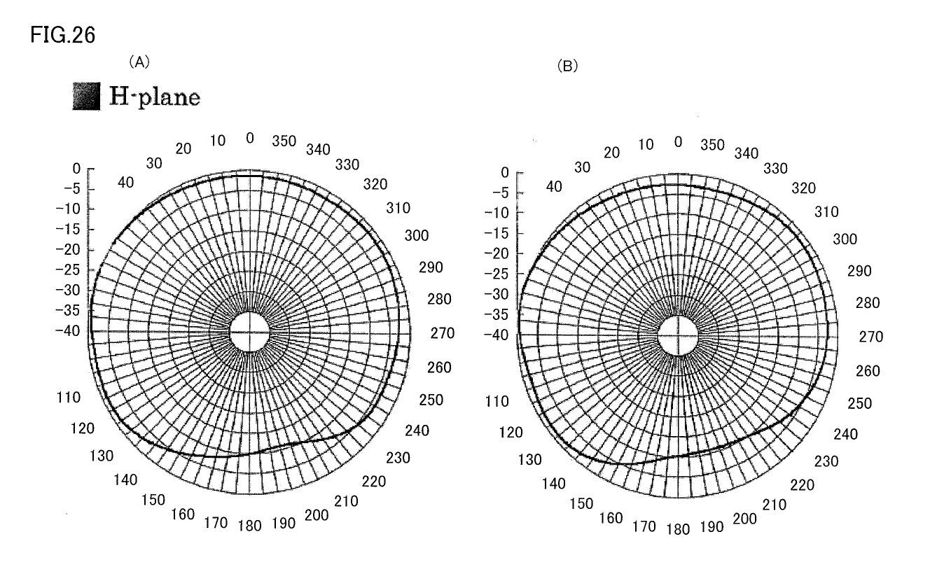

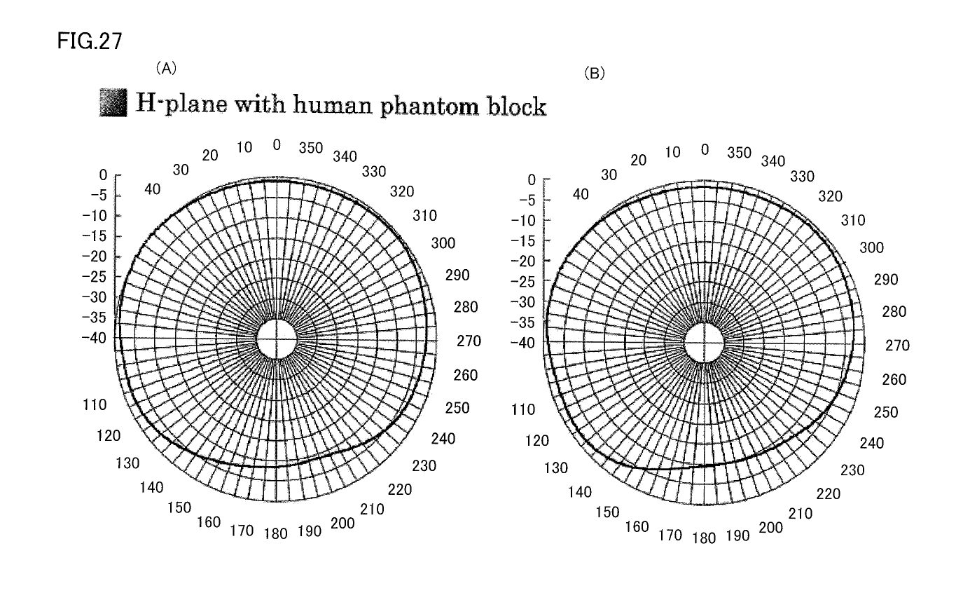

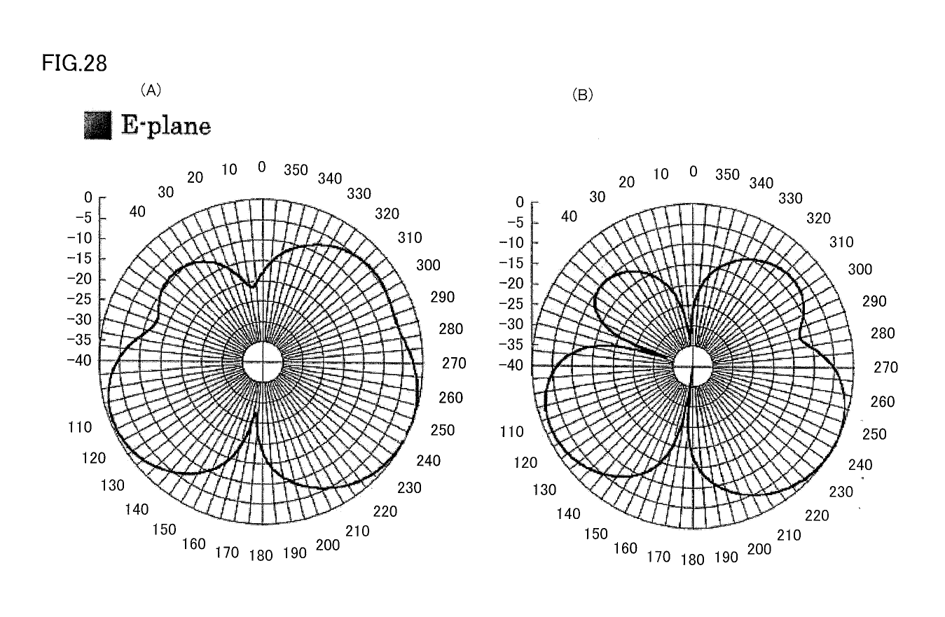

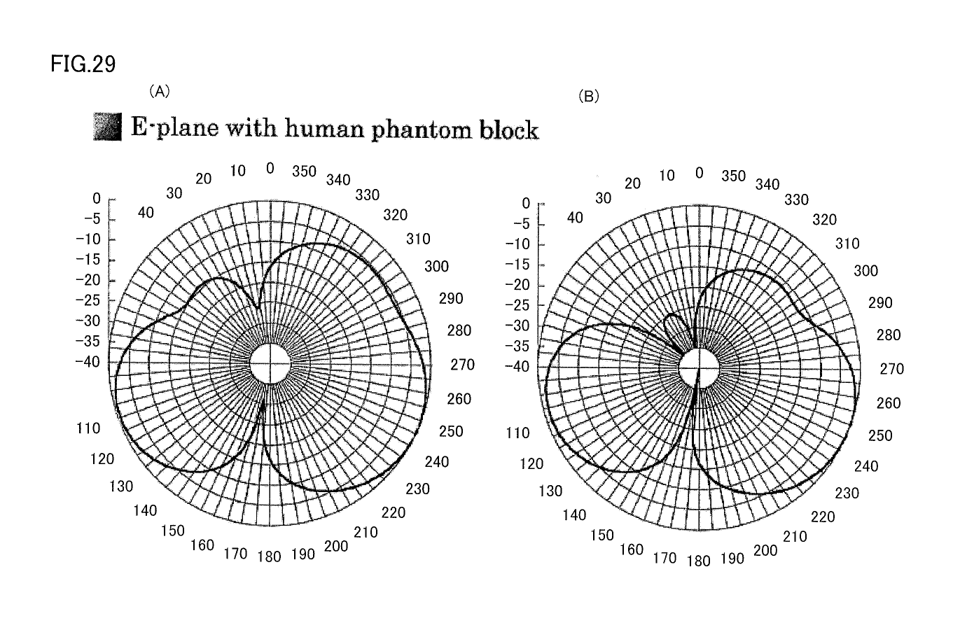

FIGS. 26-29 show the measurement results of antenna characteristics for the H-plane of case 2, the H-plane of case 3, the E-plane of case 2, and the E-plane of case 3. Item (A) of FIGS. 26-29 represent data related to the sample according to the comparative example, and item (B) of FIGS. 26-29 represent data related to the sample according to the example of the present invention. The values shown in the outer periphery of FIGS. 26-29 represent angles of orientation in each plane from the position of the measured object, and the distance from the center of the graph (center of the circle) to the curve line graph represents a relative value of field intensity (value standardized to have a maximum value of 0 dB). As can be seen in FIGS. 26-29, the example of the present invention has substantially the same antenna characteristics as the comparative example.

### Example 2

The following simulation experiment was conducted to confirm the effect of the present invention.

<Calculated Objects>

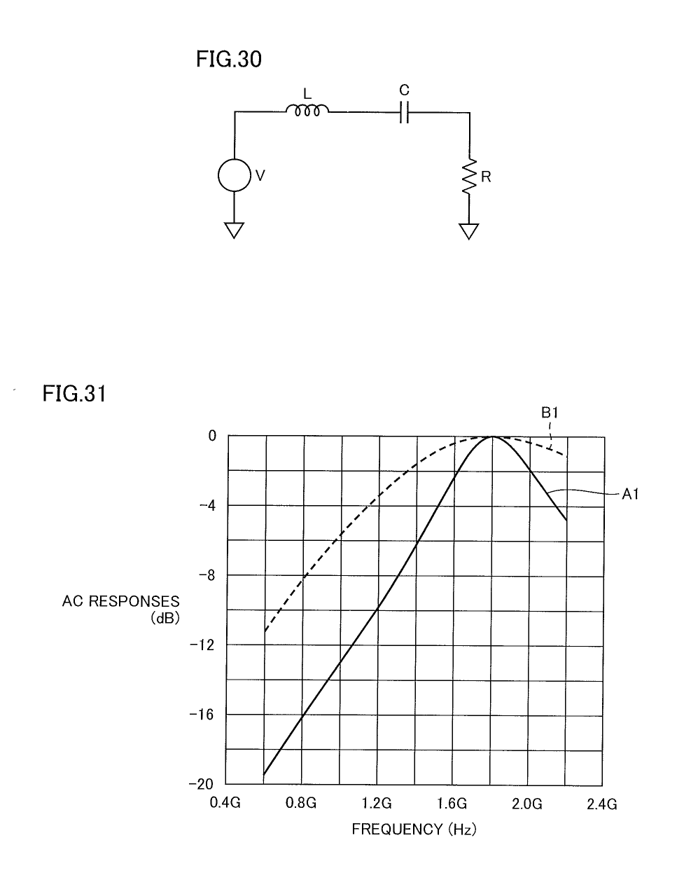

The antenna apparatus according to the example of the present invention employing material for a base having a relative permittivity of 13 and an antenna apparatus according to a comparative example employing material for a base having a similar shape and a relative permittivity of 3 were the calculated objects. The equivalent circuit shown in FIG. 30 was envisioned for the antenna apparatuses of the calculated objects.

For the example of the present invention, the equivalent circuit shown in FIG. 30 was set to have a voltage of 10V for a power source V, an inductance of 5.81 nH for an inductor L, a capacitance of 1.35 pF for a capacitor C, and an electric resistance of 50Ω for a resistor R. Further, for the comparative example, the equivalent circuit shown in FIG. 30 was set to have a voltage of 10V for power source V, an inductance of 15.5 nH for inductor L, a capacitance of 0.504 pF for capacitor C, and an electric resistance of 50Ω for a resistor R.

<Calculation Method>

For the example of the present invention and the comparative example described above, an AC analysis was conducted. Particularly, an alternate current voltage was applied to the equivalent circuit shown in FIG. 30 to calculate a frequency dependency in the operation of the circuit by using simulated calculation.

The conditions for simulation include: the condition of employing the above-described condition of the equivalent circuit (Case 1); the condition of envisioning the case where a person holds mobile equipment including the antenna apparatus and increasing the value of capacitance by only 0.5 pF (specifically, setting the value of capacitance of the example to be 1.85 pF, and setting the value of capacitance of the comparative example to be 1.004 pF) (Case 2); and the condition of envisioning the case where a person similarly holds mobile equipment and increasing the value of capacitance by only 1.0 pF (specifically, setting the value of capacitance of the example to be 2.35 pF, and setting the value of capacitance of the comparative example to be 1.504 pF).

<Results>

The results of calculation are shown in FIGS. 31-33. The vertical axis of FIGS. 31-33 represents a gain (unit: dB), and the horizontal axis represents a frequency (unit: Hz) of an applied electric current. FIG. 31 represents data of the example (graph B1) and data of the comparative example (graph A1) for Case 1. In any of the data, the gain reaches maximum at the resonance frequency of 1.8 GHz. The change ratio of the gain near the resonance frequency is smaller in the data of the example (graph B1) than the data of the comparative example (graph A1).

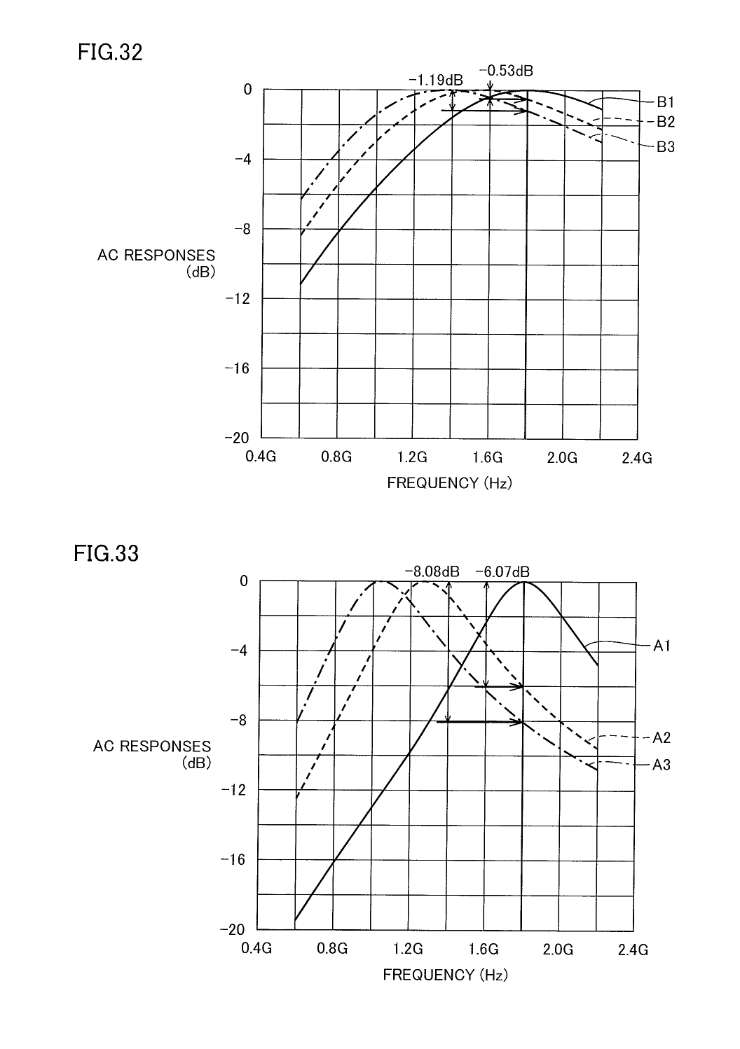

Further, as shown in FIG. 32, for the example, the resonance frequencies in Cases 2 and 3 were shifted to the low-frequency side more than in Case 1. At the resonance frequency of Case 1, the gain was reduced by 0.53 dB in Case 2, and the gain was reduced by 1.19 dB in Case 3.

On the other hand, as shown in FIG. 33, also for the comparative example, the resonance frequencies in Cases 2 and 3 were shifted to the low-frequency side more than in Case 1. At the resonance frequency of Case 1, the gain was lowered by 6.07 dB in Case 2, and the gain was lowered by 8.08 dB in Case 3.

One reason for occurrence of significant difference in lowering of gains for Cases 2 and 3 at the resonance frequency of Case 1 as described above is considered to be due to smaller shift amount of the resonance frequency to the low-frequency side and smaller change rate of gain near the resonance frequency in the example of the present invention as compared to the comparative example. The smaller lowering in gains of Cases 2 and 3 envisioning the case where a person holds mobile equipment in hand means that the change in antenna characteristics is small (loss is small) in the case where a person holds mobile equipment. This can accordingly suppress lowering of efficiency in transmission of signals in the antenna apparatus, and contribute to achievement of antenna apparatus and mobile equipment capable of reducing power consumption.

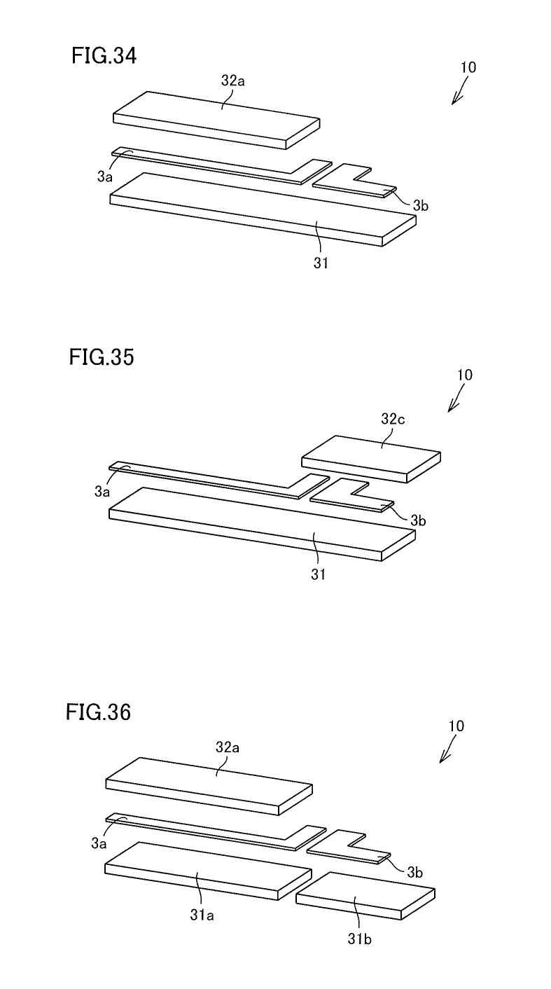

Antenna apparatus 10 shown in FIG. 15 described above may employ the configuration as will be described herebelow. In the following, modified examples of antenna apparatus 10 shown in FIG. 15 will be described with reference to FIGS. 34-36. FIGS. 34-36 are exploded schematic views for describing constituting elements of antenna apparatus 10, similarly to FIG. 15.

Antenna apparatus 10 shown in FIG. 34 basically has a structure similar to that of antenna apparatus 10 shown in FIG. 15, but is different from antenna apparatus 10 shown in FIG. 15 in the number of components constituting the base. In particular, second base 32a is arranged so as to oppose first base 31 through antenna conductor 3a. On the other hand, a second base is not arranged at a position opposing first base 31 through antenna conductor 3b. In a different point of view, one antenna conductor 3a of two antenna conductors 3a, 3b is sandwiched between first base 31 and second base 32a. The other antenna conductor 3b is fixed on a surface of first base 31 (surface opposing second base 32a) and exposed outside. One antenna conductor 3a is longer (larger in size) than the other antenna conductor 3b. Antenna conductor 3a relatively larger in size may be, for example, an antenna conductor for a low band (for a frequency band from about 0.7 GHz to 1.7 GHz), and antenna conductor 3b relatively smaller in size may be an antenna conductor for a high band (for a frequency band from about 1.7 GHz to 5 GHz). Such configuration can also achieve the effect substantially the same as that of antenna apparatus 10 shown in FIG. 15. In other words, antenna conductor 3a relatively larger in size (for a relatively lower frequency band) is sandwiched between first base 31 and second base 32a, so that antenna conductor 3a can be surrounded by first base 31 and second base 32a made of material with a high relative permittivity. Therefore, the wavelength of a signal propagated to antenna conductor 3a can be shortened assuredly, so that antenna apparatus 10 can be miniaturized effectively.

With reference to FIG. 35, another modified example of the antenna apparatus shown in FIG. 15 will be described. The antenna apparatus shown in FIG. 35 basically has a structure similar to that of antenna apparatus 10 shown in FIG. 16, but is different in the number of components constituting the base. In particular, second base 32c is arranged so as to oppose first base 31 through antenna conductor 3b. On the other hand, a second base is not arranged at a position opposing first base 31 through antenna conductor 3a. In a different point of view, one antenna conductor 3b of two antenna conductors 3a, 3b is sandwiched between first base 31 and second base 32c. The other antenna conductor 3a is fixed on a surface of first base 31 (surface opposing second base 32c) and exposed outside. Such configuration can also achieve the effect substantially the same as antenna apparatus 10 shown in FIG. 16. As shown in FIGS. 34 and 35, second base 32a or second base 32c may be arranged so as to cooperate with first base 31 to sandwich any one of the plurality of antenna conductors 3a, 3b (or at least a part of the antenna conductors 3a, 3b).

With reference to FIG. 36, another modified example of the antenna apparatus shown in FIG. 15 will be described. The antenna apparatus shown in FIG. 36 basically has a structure similar to that of antenna apparatus 10 shown in FIG. 17, but is different in the number of components constituting the base. In particular, second base 32a is arranged so as to oppose first base 31a through antenna conductor 3a. On the other hand, a second base is not arranged at a position opposing first base 31b through antenna conductor 3b. In a different point of view, one antenna conductor 3a of two antenna conductors 3a, 3b is sandwiched between first base 31a and second base 32a. The other antenna conductor 3b is fixed on a surface of first base 31b (surface opposing second base 32a) and exposed outside. Such configuration can also achieve the effect substantially the same as antenna apparatus 10 shown in FIG. 17. Further, in FIG. 36, second base 32c shown in FIG. 35 may be arranged in place of second base 32a on antenna conductor 3b. Further, second base 32a (or second base 32c) may be arranged so as to oppose first base 31a (or first base 31b) and cover at least a part of antenna conductor 3a (or antenna conductor 3b).

Although some parts will overlap with the embodiments described above, the configuration particular to the present invention will be described.

Antenna apparatus 10 according to the present invention includes base 1, antenna conductor 3, and terminal 5 as an external connection terminal. Base 1 is made of a dielectric composite material containing resin and ceramic powder. Antenna conductor 3 is connected to base 1. Terminal 5 is electrically connected to antenna conductor 3. A relative permittivity (∈ᵣ) and a dielectric tangent (tan δ) of the dielectric composite material satisfy the relation of: tan δ≦0.0024×e^{(0.0341×∈r)}.

According to the manner described above, setting the relative permittivity to be greater than that of the base employed in the conventional antenna apparatus can shorten the wavelength of a signal propagated to antenna apparatus 10. Therefore, antenna apparatus 10 can be miniaturized. Further, employing the dielectric composite material containing resin and ceramic powder can reduce the dielectric tangent of antenna apparatus 10 sufficiently. Therefore, the energy loss can be reduced in the antenna apparatus 10. Consequently, antenna apparatus 10 having superior characteristics can be achieved.

Antenna apparatus 10 described above may further include flexible substrate 2 provided with antenna conductor 3. Flexible substrate 2 may be fixed to the surface of base 1. In this case, flexible substrate 2 having antenna conductor 3 formed thereon in advance is fixed to the surface of base 1. Therefore, antenna apparatus 10 according to the present invention can be readily manufactured. Further, since antenna conductor 3 is not formed directly on base 1, the surface of base 1 may be of a form that does not have a shape readily allow antenna conductor 3 to be formed directly on the surface of base 1 (for example, a curved shape and an irregular shape).

In antenna apparatus 10 described above, antenna conductor 3 may be fixed directly to the surface of base 1, as shown in FIG. 5. In this case, by virtue of antenna conductor 3 fixed directly to the surface of base 1, antenna apparatus 10 can be miniaturized further than the case where flexible substrate 2 having antenna conductor 3 arranged on the surface thereof is fixed to base 1.

In antenna apparatus 10 described above, the surface of base 1 may including a curved portion as shown in FIGS. 1-3, and 5. Antenna conductor 3 may be arranged on the curved portion. In this case, when the shape of the surface of base 1 is curved so as to be in conformity with the shape of a casing of electronic equipment incorporating antenna apparatus 10, and the curved portion is arranged to be in conformity with an inner wall of the casing, antenna conductor 3 can be arranged in proximity to the inner wall of the casing.

In antenna apparatus 10 described above, the relative permittivity of the dielectric composite material constituting base 1 may be greater than or equal to 4 and less than or equal to 50. According to the manner described above, the change in antenna characteristics in the case where a human body is located in proximity to antenna apparatus 10 can be suppressed further than the conventional antenna.

In antenna apparatus 10, the amount of reduction in gain may be less than or equal to 4 dB when the electrostatic capacitance of the capacitor constituting the equivalent circuit of the antenna apparatus is increased by 1.0 pF at the resonance frequency. In this case, when a person holds electronic equipment including the antenna apparatus (for example, mobile equipment 20), deterioration in the characteristics of the antenna apparatus (reduction in gain) can be suppressed sufficiently. Therefore, the antenna characteristics in the case where a person holds antenna apparatus 20 can be maintained favorably, and lowering in transmission efficiency in the antenna apparatus due to deterioration in antenna characteristics can be suppressed, so that power consumption of mobile equipment 20 can be reduced.

In antenna apparatus 10, antenna conductor 3 may be held in base 1. In this case, since base 1 made of high dielectric material with a high relative permittivity surrounds a periphery of antenna conductor 3, the wavelength of the signal propagated to antenna conductor 10 can be further miniaturized. Further, since antenna conductor 3 is covered with base 1, base 1 can be used as an insulating covering layer for antenna conductor 3.

Antenna apparatus 10 described above may be employed in mobile equipment 20.

Antenna apparatus 10 according to the present invention includes base 1, antenna conductor 3, and external connection terminal 5. Base 1 is made of a dielectric composite material containing resin and ceramic powder. Antenna conductor 3 is arranged on the surface of the base. External connection terminal 5 is electrically connected to antenna conductor 3. The relative permittivity of the dielectric composite material is greater than or equal to 4 and less than or equal to 50.

According to the manner described above, setting the relative permittivity to be greater than that of base 1 employed in conventional antenna apparatus 10 can shorten the wavelength of a signal propagated to antenna apparatus 10. Therefore, antenna apparatus 10 can be miniaturized. Further, even in the state where a human body is located in proximity to mobile equipment 20 adopting antenna apparatus 10 (for example, in the state where a user holds mobile equipment 20 in hand), the change in characteristics of antenna apparatus 10 can be suppressed further as compared to the state where the human body is not located in proximity to mobile equipment 20.

Preferably, as to antenna apparatus 10 described above, the relative permittivity of the dielectric composite material constituting base 1 is greater than 10, and the dielectric tangent is less than or equal to 0.003. Further, the relative permittivity of the dielectric composite material may be greater than or equal to 15, and the dielectric tangent may be less than or equal to 0.0035. Furthermore, the relative permittivity of the dielectric composite material may be greater than or equal to 20, and the dielectric tangent may be less than or equal to 0.004. In this case, the antenna apparatus can be miniaturized and improved assuredly.

Further, as the ceramic powder contained in the dielectric composite material constituting base 1, powder made of titanium oxide or titanate can be employed. Preferably, titanate exhibiting a high dielectricity, such as calcium titanate, barium titanate, strontium titanate, magnesium titanate, lead titanate, calcium-magnesium titanate, neodymium titanate, and the like may be employed.

Further, as the resin contained in the dielectric composite material, thermosetting resin, such as epoxy resin, thermosetting polyimide resin, and the like can be employed. Employing thermoplastic resin is preferable in view of capability to apply melt processing such as injection molding.

Preferably, the thermoplastic resin may be: polyolefin resin such as polyethylene (low-density polyethylene, mid-density polyethylene, high-density polyethylene, linear low-density polyethylene, and ultralow-density polyethylene), polypropylene, and the like; polystyrene resin such as polystyrene, syndiotactic polystyrene, modified polystyrene, and the like; polyphenylene oxide resin; polyphenylene sulfide resin; and the like. Other than these resins, thermoplastic resin may be a liquid crystal polymer, ABS resin, thermoplastic polyester resin, polyacetal resin, polyamide resin, methylpentene resin, cyclic olefin resin, polycarbonate resin, thermofusion fluororesin, thermoplastic polyimide resin, polyetherimide resin, and the like. These synthetic resins may be used independently or in combination of two or more types.

Among these synthetic resins, resin exhibiting a low dielectric tangent in a high-frequency range, such as polyolefin resin, polystyrene resin, polyolefin oxide resin, polyphenylene sulfide resin, and the like is preferable. Among these synthetic resins, polyolefin resin is preferable in view of dielectricity and melt workability, and polypropylene is particularly preferable in view of thermal resistance and ceramics repletion.

The polypropylene may include a homopolymer, a random copolymer, a block copolymer, and the like. The copolymer is formed by a combination of propylene with ethylene or with α-olefin (1-butene, 1-hexene, 4-methyl-1-pentene, 1-octene, and the like).

Although the present invention has been described and illustrated in detail, it is clearly understood that the same is by way of illustration and example only and is not to be taken by way of limitation, the scope of the present invention being interpreted by the terms of the appended claims.

What is claimed is:

1. An antenna apparatus, comprising:
a base made of a dielectric composite material containing resin and ceramic powder;
an antenna conductor connected to said base; and
an external connection terminal electrically connected to said antenna conductor, wherein
a relative permittivity (∈ᵣ) and a dielectric tangent (tan δ) of said dielectric composite material satisfy a relation of: tan δ≦0.0024×e^{(0.0341×∈r)}.

2. The antenna apparatus according to claim 1, further comprising:
a flexible substrate provided with said antenna conductor,
said flexible substrate being fixed to the surface of said base.

3. The antenna apparatus according to claim 1, wherein said antenna conductor is fixed directly to the surface of said base.

4. The antenna apparatus according to claim 1, wherein the surface of said base includes a curved portion, and
said antenna conductor is arranged on said curved portion.

5. The antenna apparatus according to claim 1, wherein the relative permittivity of said dielectric composite material is greater than or equal to 4 and less than or equal to 50.

6. The antenna apparatus according to claim 1, wherein the amount of reduction in gain is less than or equal to 4 dB when an electrostatic resistance of a capacitor constituting an equivalent circuit of said antenna apparatus is increased by 1.0 pF at a resonance frequency.

7. The antenna apparatus according to claim 1, wherein said antenna conductor is held in said base.

8. The antenna apparatus according to claim 1, wherein said antenna apparatus is employed in mobile equipment.

9. An antenna apparatus, comprising:
a base made of a dielectric composite material containing resin and ceramic powder;
an antenna conductor arranged on a surface of said base; and
an external connection terminal electrically connected to said antenna conductor, wherein
a relative permittivity of said dielectric composite material is greater than or equal to 4 and less than or equal to 50.
